(19) United States
(12) Patent Application Publication
(10) Pub. No.: US 2024/0303115 A1
(43) Pub. Date: Sep. 12, 2024

(54) INFORMATION PROCESSING APPARATUS AND PROGRAM

(71) Applicant: FELICA NETWORKS, INC., TOKYO (JP)

(72) Inventor: JUNJI GOTO, TOKYO (JP)

(21) Appl. No.: 18/546,253

(22) PCT Filed: Jan. 13, 2022
(86) PCT No.: PCT/JP2022/000816

§ 371 Date: Aug. 11, 2023

(30) Foreign Application Priority Data
Feb. 19, 2021 (JP) 2021-024926

(51) Int. Cl. G06F 9/50

(52) U.S. Cl. CPC G06F 9/5016

(57) ABSTRACT

The present technology relates to an information processing apparatus and a program that enable effective use of a memory area in which implementation data necessary for implementation of a service is stored in an allocation area allocated to each service. A process is performed in which an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, is changed to a service-undetermined allocation area not allocated to any of the services, and thereafter a service issuance process of storing the implementation data corresponding to a new service in the service-undetermined allocation area is performed.

### TECHNICAL FIELD

The present technology relates to an information processing apparatus and a program, and more particularly, to an information processing apparatus and a program that enable effective use of a memory area in which implementation data necessary for implementation of a service is stored in an allocation area allocated for each service.

### BACKGROUND ART

Patent Document 1 describes a technology related to a multi-application IC chip in which applications corresponding to a plurality of services are stored.

### CITATION LIST

### Patent Document

Patent Document 1: Japanese Patent Application Laid-Open No. 2019-046211

### SUMMARY OF THE INVENTION

### Problems to be Solved by the Invention

In a memory area in which implementation data necessary for implementation of a service is stored in an allocation area allocated for each service, an allocation area allocated to a deleted service remains, and hence implementation data corresponding to a new service cannot be stored, in some cases. In such a case, the memory area cannot be effectively used.

The present technology has been made in view of such circumstances, and enables effective use of a memory area in which implementation data necessary for implementation of a service is stored in an allocation area allocated for each service.

### Solutions to Problems

An information processing apparatus or a program according to a first aspect of the present technology is an information processing apparatus including a processing unit configured to rform a process of changing an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area, or a program that causes a computer to function as the above-described information processing apparatus.

According to the first aspect of the present technology, a process is performed in which an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, is changed to a service-undetermined allocation area not allocated to any of the services, and thereafter a service issuance process of storing the implementation data corresponding to a new service in the service-undetermined allocation area is performed.

An information processing apparatus according to a second aspect of the present technology is an information processing apparatus including a command generation unit configured to transmit, to a terminal apparatus configured to change an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area, a command for performing the service issuance process.

According to the second aspect of the present technology, to a terminal apparatus configured to change an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area, a command for performing the service issuance process is transmitted.

### BRIEF DESCRIPTION OF DRAWINGS

FIG. 1 is a block diagram illustrating a configuration example of an embodiment of an information processing system to which the present technology is applied.

FIG. 2 is a diagram illustrating management of a SE of a contactless IC chip of an information processing apparatus by a TSM server.

FIG. 3 is a diagram illustrating an example of a logical configuration of a memory area of the SE of the contactless IC chip.

FIG. 4 is a diagram illustrating a case where a service loaded into the contactless IC chip is deleted by a GP-compatible TSM server in FIG. 1.

FIG. 5 is a diagram illustrating a case where a service loaded into the contactless IC chip is deleted by a GP-incompatible TSM server.

FIG. 6 is a diagram illustrating an outline of a service issuance process performed on an Applet instance in a blank personalized state by the TSM server of the present embodiment.

FIG. 7 is a diagram illustrating a configuration concerning service issuance to the contactless IC chip of the information processing apparatus in the information processing system in FIG. 1.

FIG. 8 is a diagram illustrating procedures for service issuance in a case where a memory area to be added with a new service remains in the SE of the contactless IC chip.

FIG. 9 is a diagram illustrating procedures for service issuance in the case where a memory area to be added with a new service remains in the SE of the contactless IC chip.

FIG. 10 is a diagram illustrating procedures for service issuance in the case where a memory area to be added with a new service remains in the SE of the contactless IC chip.

FIG. 11 is a diagram illustrating procedures for service issuance to an Applet instance in a blank personalized state in a case where no memory area to be added with a new service remains in the SE of the contactless IC chip.

FIG. 12 is a diagram illustrating procedures for service issuance to an Applet instance in a blank personalized state in the case where no memory area to be added with a new service remains in the SE of the contactless IC chip.

FIG. 13 is a diagram illustrating procedures for service issuance to an Applet instance in a blank personalized state in the case where no memory area to be added with a new service remains in the SE of the contactless IC chip.

FIG. 14 is a diagram illustrating procedures for service issuance to an Applet instance in a blank personalized state in the case where no memory area to be added with a new service remains in the SE of the contactless IC chip.

FIG. 15 is a diagram illustrating procedures for service issuance to an Applet instance in a blank personalized state in the case where no memory area to be added with a new service remains in the SE of the contactless IC chip.

FIG. 16 is a diagram illustrating procedures for service issuance to an Applet instance in a blank personalized state in the case where no memory area to be added with a new service remains in the SE of the contactless IC chip.

FIG. 17 is a sequence diagram illustrating procedures for a service issuance process in the information processing system.

FIG. 18 is a sequence diagram illustrating procedures for a service issuance process in the information processing system.

FIG. 19 is a block diagram illustrating a configuration example of hardware of a computer that performs a series of processes in accordance with a program.

### MODE FOR CARRYING OUT THE INVENTION

Hereinafter, an embodiment of the present technology will be described with reference to the drawings.

### <Embodiment of Information Processing System>

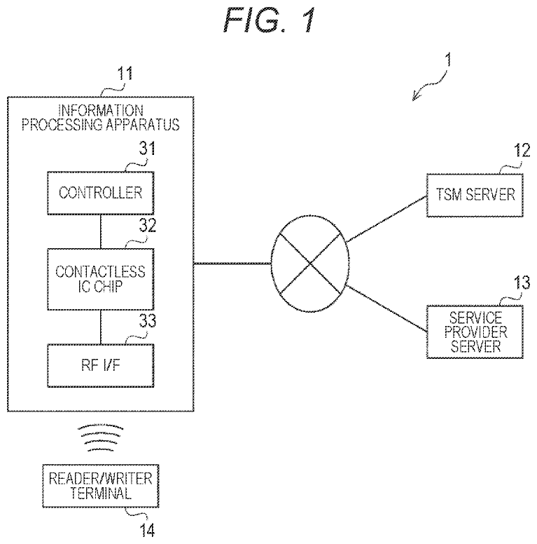

FIG. 1 is a block diagram illustrating a configuration example of an embodiment of an information processing system to which the present technology is applied.

In FIG. 1, an information processing system 1 that is the embodiment of the information processing system to which the present technology is applied includes an information processing apparatus 11, a trusted service manager (TSM) server 12, a service provider server 13, and a reader/writer terminal 14.

The information processing apparatus 11, the TSM server 12, and the service provider server 13 are connected so as to be capable of communicating to/from each other via a network such as a local area network, the Internet, or a mobile communication network. The information processing apparatus 11 and the reader/writer terminal 14 are connected so as to be capable of communicating to/from each other through near field communications (NFC).

The information processing apparatus 11 is a terminal apparatus compatible with NFC between smartphones, mobile phones, or the like. The information processing apparatus 11 includes a controller 31, a contactless IC chip 32, and a radio frequency (RF) interface 33.

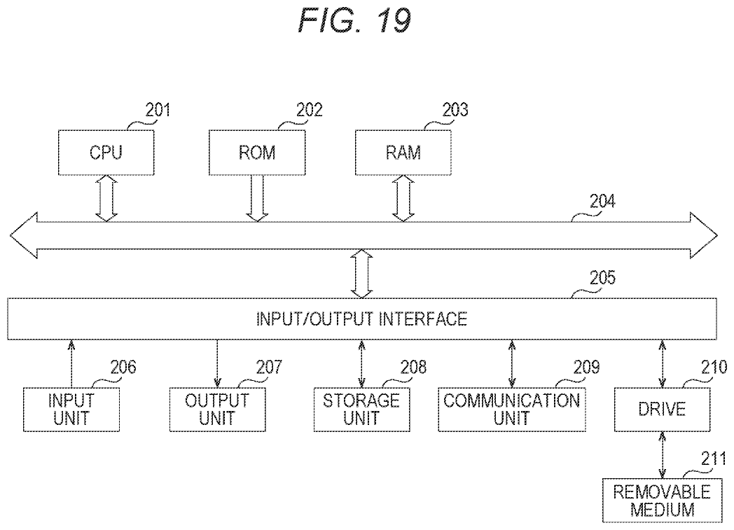

The controller 31 has a configuration similar to that of a computer in FIG. 19. Specifically, the controller 31 includes a central processing unit (CPU), a nonvolatile memory (for example, a flash memory or the like) in which various programs and data are stored, a RAM in which data is temporarily stored, a communication circuit that is connected to a network so as to be capable of communicating to/from a network, an I/O port that performs data transmission to/from the contactless IC chip 32, and the like.

The controller 31 executes an operating system (OS), predetermined middleware, and a program of a predetermined application, to perform transmission of various data to/from the contactless IC chip 32, relaying of transmission of various data between the TSM server 12 or the service provider server 13 and the contactless IC chip 32, and the like.

The contactless IC chip 32 includes a CPU, a RAM, a ROM, a nonvolatile memory, an I/O port, and the like. The I/O port performs data transmission to/from the controller 31 and the RF interface 33. In the non-volatile memory, an OS, various applications, and data used in the OS and the various applications are stored.

The RF interface 33 receives and demodulates an electromagnetic wave (modulated wave) from the reader/writer terminal 14 in a frequency band of a HF band (shortwave band of 13.56 MHz) using an antenna (not illustrated), and supplies data transmitted by the modulated wave to the contactless IC chip 32. The RF interface 33 modulates a carrier wave of 13.56 MHz in accordance with data from the contactless IC chip 32 to generate a modulated wave, and transmits an electromagnetic wave (modulated wave) in a HF band from the antenna (not illustrated) to the reader/writer terminal 14.

The RF interface 33 conforms to, for example, the NFC Forum specification. Specifically, the RF interface 33 performs modulation and demodulation compatible with the communication technology of Type-A/B defined in the international standard ISO/IEC 14443 of contactless IC cards, and the communication technology of Type-F defined in the international standard ISO/IEC 18092 (NFCIP-1) of the communication protocol, i.e., the communication technology of FeliCa (registered trademark) that is a technological scheme of contactless IC cards. Therefore, when the RF interface 33 and the reader/writer terminal 14 conforming to the NFC Forum specification are brought close to each other to have an interval of about several centimeters therebetween, near field communication (NFC) between them becomes possible.

Note that portions of the RF interface 33 other than the antenna may be incorporated into the contactless IC chip 32.

Here, the information processing apparatus 11 is an NFC-compatible terminal apparatus, and has, for example, a card emulation function, a card reader/writer function, and a peer-to-peer function. The card emulation function is a function of performing a function of an IC card (an electronic money card, a credit card, or the like) with an information processing apparatus that is an apparatus different from the IC card. The card reader/writer function is a function of reading and writing data included in an IC card. The peer-to-peer function is a function of performing communication between NFC-compatible apparatuses through NFC.

In order to perform these functions, an analog frontend block (contactless frontend (CLF)) and a secure element (SE) are mounted in the information processing apparatus 11, in addition to the controller 31. The CLF and the SE are formed by the contactless IC chip 32 and the RF interface 33.

The CLF performs near field communication to/from an NFC-compatible apparatus, and relays data transmission between an NFC-compatible apparatus and the SE, data transmission between an NFC-compatible apparatus and the controller 31, and data transmission between the controller 31 and the SE.

The SE has a highly confidential memory area (non-volatile memory) and a calculation function (processor or the like) specialized in encryption, and stores data and encrypts/decrypts data. Note that examples of the method of mounting the SE include an embedded method, a SIM method, and an SD card method. The embedded method is a method of incorporating the SE into an IC chip built in a terminal. The SIM method is a method in which a SE is mounted in a universal integrated circuit card (UICC) (SIM card) provided by a mobile-phone carrier. The SD card method is a method in which the SE is mounted in an external medium such as an SD card. The present embodiment shows a case where the embedded method in which the SE is incorporated in the contactless IC chip 32 is adopted as a method of mounting the SE, as an example, but any other method may be adopted.

The TSM server 12 is a server owned by an area manager that manages the memory area of the SE of the information processing apparatus 11. The TSM server 12 performs management of the SE, such as allocation of the memory area of the SE to a service provider (SP) that provides a service using the SE, installation of an application (Applet) necessary for providing a service onto the memory area of the SE, and the like. Note that, in the present specification, the term “service” includes a service that can be provided by way of an IC card such as a traffic ticket, electronic money, a credit card, a student card, a membership card, a loyalty card, a coupon, or an apartment key, or something that provides such a service (application or the like). Regarding the number of services, a service provider or a purpose of using a service is a unit of the service. That is, in a case where there are different service providers that provide services having the same content, the services are dealt as separate services.

The service provider server 13 is a server owned by the SP. The service provider server 13 receives an access (such as reading or writing of data) to the memory area of the SE allocated to a service provided by itself, a request for issuance of a new service from a user using an application, and the like.

The reader/writer terminal 14 is an NFC-compatible apparatus. When the information processing apparatus 11 is brought close to the reader/writer terminal 14, the reader/writer terminal 14 is connected to the information processing apparatus 11 so as to be capable of communicating to/from each other through near field communication (NFC) in the same manner as in a case where an NFC-compatible IC card is brought close thereto, and makes an access to the memory area of the SE of the information processing apparatus 11 (reading and writing of data in the memory area in accordance with a command or the like).

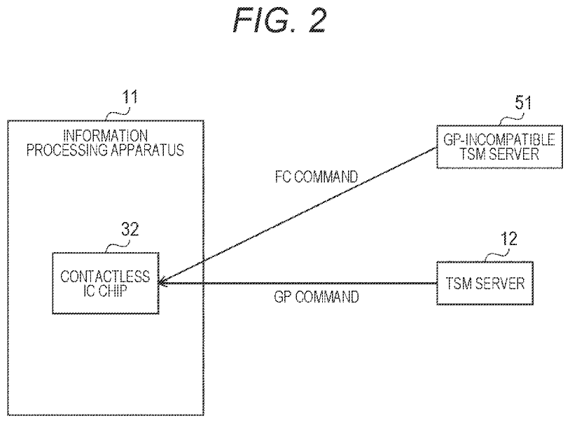

FIG. 2 is a diagram illustrating management of the SE of the contactless IC chip 32 of the information processing apparatus 11 by the TSM server.

The contactless IC chip 32 of the information processing apparatus 11 conforms to the technical specifications defined in GlobalPlatform card specification versions 2.1.1 and 2.2. GlobalPlatform (GP) is an industry standard organization for multi-application IC card management systems. Hereinafter, the technical specification formulated in GP is simply referred to as GP.

The GP-compatible contactless IC chip 32 can be used in a multi-application platform. The multi-application platform enables loading of a plurality of services that emulates an IC card in a memory area of one SE, and allows a user to add or delete a service in accordance with the user's intention.

In addition to a FeliCa (registered trademark)-compatible service provided using FeliCa (registered trademark) technology, a service provided using the Type-a/b technology of ISO/IEC 14443 can be loaded (registered) into the GP-compatible contactless IC chip 32 and can be used by a user.

A GP-incompatible TSM server 51 in FIG. 2 is a TSM server that manages a SE of a contactless IC chip compatible only with FeliCa (registered trademark). The GP-compatible TSM server 12 of the present embodiment is a TSM server that manages the SE of the GP-compatible contactless IC chip 32.

The FeliCa (registered trademark)-compatible service loaded into the SE of the GP-compatible contactless IC chip 32 can be managed using a FC command from the GP-incompatible TSM server 51 or a GP command from the GP-compatible TSM server 12 of the present embodiment. The FC command is a command defined by FeliCa (registered trademark), and the GP command is a command defined by GP. However, services other than FeliCa (registered trademark) loaded into the SE of the GP-compatible contactless IC chip 32 cannot be managed by the FC command from the GP-incompatible TSM server 51, in some cases.

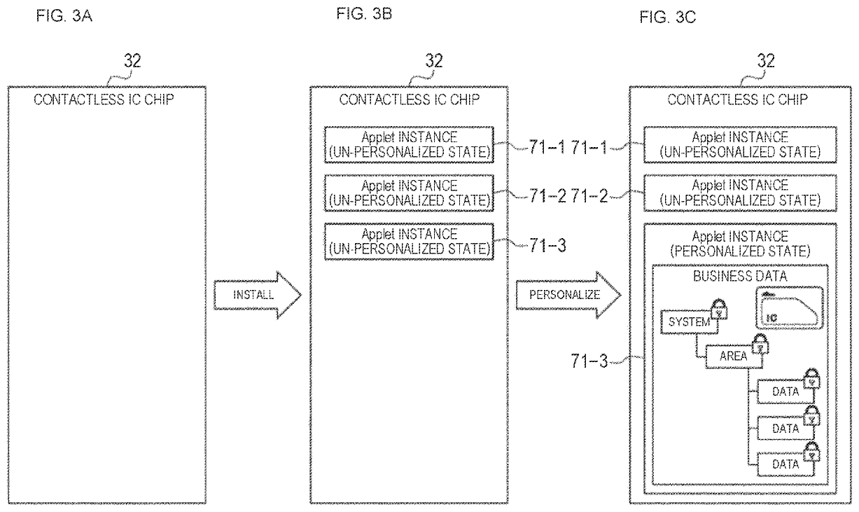

FIG. 3 is a diagram illustrating an example of a logical configuration of the memory area of the SE of the contactless IC chip 32.

A state A in FIG. 3 is a state in which no service is loaded into the SE of the contactless IC chip 32.

A state B is a state in which an application (Applet) corresponding to a service is installed on the contactless IC chip 32. When the Applet corresponding to the service is installed, a memory area (allocation area) used for the service is allocated in the memory area of the SE. An Applet instance generated by an installation process of the Applet is stored in the allocation area. The Applet instance is also referred to as an application because a function of an application corresponding to a service is performed by execution of the Applet instance. In the example of FIG. 3, for example, three Applet instances 71-1, 71-2, and 71-3 corresponding to FeliCa (registered trademark) services are stored in respective memory areas allocated thereto.

Note that, in the memory area of the SE, an allocation area is allocated to each service, and implementation data necessary for implementation of each service is stored in the allocation area allocated to each service. As one of pieces of the implementation data, an Applet instance that causes the processor of the SE to perform a process corresponding to the service is included.

Here, in a case where an Applet instance is in an un-personalized state in which the Applet instance is not personalized (described later), a service is not implemented, and the allocation area in which the Applet instance is stored is tantamount to being not allocated to any service. Thus, an allocation area in a case where an Applet instance is in an un-personalized state is referred to as a service-undetermined allocation area. An allocation area in a case where an Applet instance is in a personalized state is in a state in which it is allocated to a predetermined service, and thus is referred to as a service-determined allocation area or is simply referred to as an allocation area.

Hereinafter, an allocation area in which an Applet instance is stored is also referred to as an allocation area or a memory area allocated to the Applet instance. In the state B of FIG. 3, all the Applet instances 71-1, 71-2, and 71-3 are in an un-personalized state, and hence, all the allocation areas respectively allocated to the Applet instances 71-1, 71-2, and 71-3 are service-undetermined allocation areas.

A state C is a state in which a part of an Applet instance stored in the SE is personalized in the contactless IC chip 32. In the example of FIG. 3, user-specific data (business data) supplied from the TSM server 12 is written to (held in) the Applet instance 71-3, as internal data, and the Applet instance 71-3 is placed in a personalized state (personalized state). When the Applet instance 71-3 is placed in a personalized state, a service corresponding to the Applet instance 71-3 becomes available. The allocation area allocated to the Applet instance 71-3 in a personalize state is a service-determined allocation area.

In the portion for the state C in FIG. 3, a logical hierarchical structure in FeliCa (registered trademark) of business data (various data held in the Applet instance 71-3) that is one of pieces of the implementation data necessary for implementation of the service, is shown in the allocation area allocated to the Applet instance 71-3 in a simplified manner, as an example. The system of the highest layer indicates a unit of a logical IC card, and a system code for specifying the system and a key for making an access to data in the shift layer or below are stored as data of the system. In the area of the lower layer of the system, data indicating the number of remaining blocks available in the memory area and allocation of the number of blocks to each piece of data in the lower layer, and a key for making an access to data in the area layer or below are stored. A block is a unit of reading and writing data.

For data in the lower layer of the area, data of each kind of service information (for example, user information, history information, and the like) and a key for making an access to the data of each kind of service information are stored. In addition, an IDm for identifying a communication partner and a PMm for identifying performance of a communication partner are stored in a memory area allocated to a service corresponding to the Applet instance 71-3. Note that writing an Applet instance generated by installation of an application corresponding to a service onto the memory area (allocation area) of the SE and causing user-specific data (business data) to be held as internal data of the Applet instance to place the Applet instance in a personalized state is referred to as issuing a service or issuance of a service (service issuance).

FIG. 3 illustrates a case where three allocation areas are generated in the memory area of the SE, as an example. The number of allocation areas may be determined in advance in accordance with the space of the memory area or the like, or allocation areas may be added or deleted depending on the free space of the memory area.

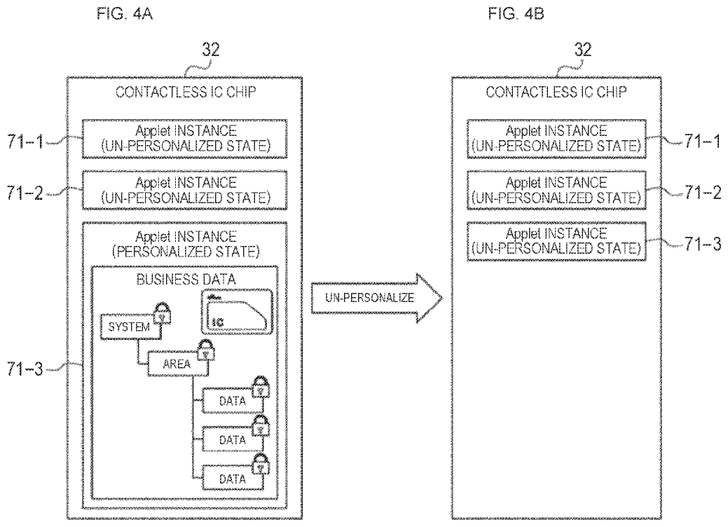

FIG. 4 is a diagram illustrating a case where a service loaded into the contactless IC chip 32 is deleted by the GP-compatible TSM server 12 in FIG. 1.

A state A in FIG. 4 is the same as the state C in FIG. 3, and the Applet instance 71-3 is in a personalized state. An allocation area allocated to the Applet instance 71-3 is a service-determined allocation area.

A state B is a state in which a service corresponding to the Applet instance 71-3 has been deleted due to card cancellation or the like. To delete a service corresponding to the Applet instance 71-3, the GP-compatible TSM server 12 deletes business data held in the Applet instance 71-3 and places the Applet instance 71-3 in an un-personalized state. That is, in the GP-compatible TSM server 12, the allocation area allocated to the Applet instance 71-3 is a service-undetermined allocation area.

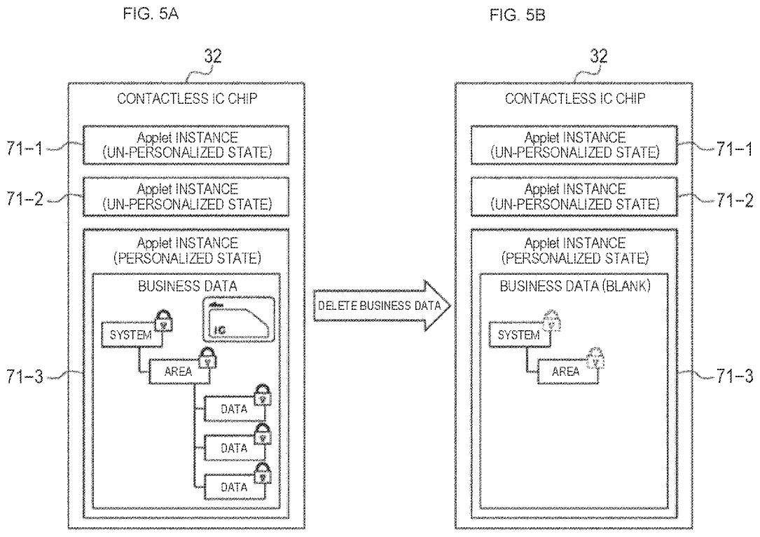

FIG. 5 is a diagram illustrating a case where a service loaded into the contactless IC chip 32 is deleted by the GP-incompatible TSM server 51.

A state A in FIG. 5 is the same as the state C in FIG. 3 and the state A in FIG. 4, and the Applet instance 71-3 is in a personalized state. An allocation area allocated to the Applet instance 71-3 is a service-determined allocation area.

A state B is a state in which a service corresponding to the Applet instance 71-3 has been deleted due to card cancellation or the like. To delete a service corresponding to the Applet instance 71-3, the GP-incompatible TSM server 51 deletes business data held in the Applet instance 71-3. However, the GP-incompatible TSM server 51 cannot perform a GP-compatible process regarding allocation of the memory area of the SE, and thus, the Applet instance 71-3 cannot be returned (changed) to an un-personalized state. That is, the allocation area allocated to the Applet instance 71-3 remains as a service-determined allocation area.

Here, it is assumed that the SE of the contactless IC chip 32 of the information processing apparatus 11 is managed by the GP-incompatible TSM server 51. In this case, it is assumed that there occurs the Applet instance 71-3 that includes blank business data and is in a personalized state in the contactless IC chip 32, as in the state B in FIG. 5.

In this situation, in a case where the GP-incompatible TSM server 51 issues a new service, if the business data is blank, a new service can be issued to the Applet instance 71-3 in a personalized state.

Meanwhile, as the GP-compatible contactless IC chip 32 becomes widespread, a GP-compatible TSM server also becomes widespread. Then, management of the SE of the contactless IC chip 32 of the information processing apparatus 11 is changed from management by the GP-incompatible TSM server 51 to management by the GP-compatible TSM server 12, in some cases. Assuming that the present technology is not applied to the GP-compatible TSM server 12, the TSM server 12 cannot issue a new service to the Applet instance 71-3 in a personalized state even with blank business data. In other words, as long as an allocation area is in a service-determined state though at least a part of implementation data necessary for implementation of a service is deleted from the allocation data, the TSM server 12 cannot issue a new service to the service-determined allocation area.

Thus, in the contactless IC chip 32, the allocation area allocated to a service that is not implemented remains in the future. As a result, a part of the memory area of the SE is not effectively used, and there may occur a situation in which the number of services that can be issued is limited to the smaller number than originally expected, or the like. The TSM server 12 of the present embodiment to which the present technology is applied prevents such a situation from occurring.

Note that, in the following description, an Applet instance that includes blank business data and is in a personalized state is referred to as an Applet instance in a blank personalized state. An Applet instance that holds business data and is in a personalized state is simply referred to as an Applet instance in a personalized state. However, a case where business data is blank is an example of a state in which at least a part of implementation data necessary for implementation of a service is deleted, and application of the present technology is not limited to this case. The present technology can be applied to a case where a new service is issued to a service-determined allocation area in a state in which at least a part of implementation data necessary for implementation of a service is deleted.

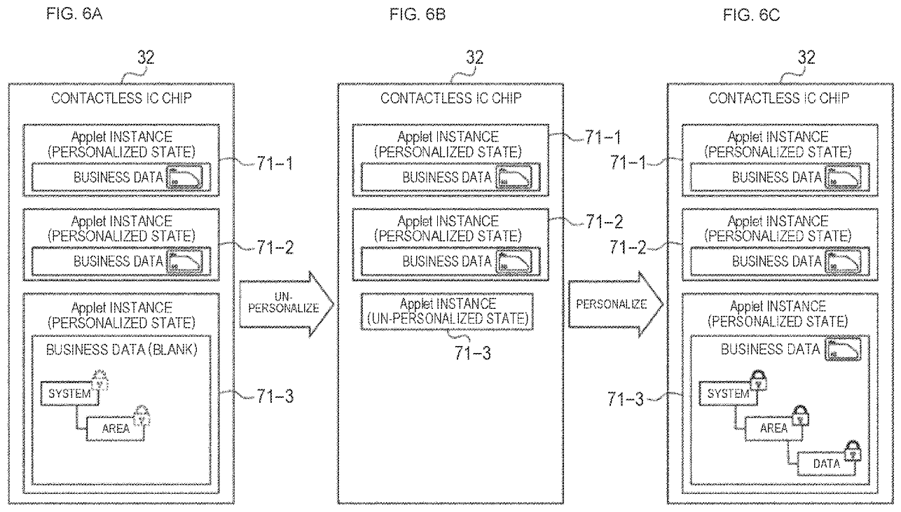

FIG. 6 is a diagram illustrating an outline of a service issuance process performed on an Applet instance in a blank personalized state by the TSM server 12 of the present embodiment.

In a state A in FIG. 6, the Applet instance 71-3 of the contactless IC chip 32 is in a blank personalized state, as in the state A in FIG. 5. However, in the state A in FIG. 6, unlike in the state A in FIG. 5, the Applet instances 71-1 and 71-2 are in a personalized state. It is assumed that a memory area (an Applet instance in an un-personalized state) in which a new Applet instance corresponding to a new service is to be stored does not remain in the SE of the contactless IC chip 32 in the state A.

In the state A as described above, for issuance of a new service, the TSM server 12 of the present embodiment first changes the Applet instance 71-3 in a blank personalized state to an un-personalized state. In other words, an allocation area allocated to the Applet instance 71-3 is returned to a service-undetermined allocation area.

A state B represents the contactless IC chip 32 in which the Applet instance 71-3 in a blank personalized state has been changed to an un-personalized state.

The TSM server 12 issues a new service to the contactless IC chip 32 in the state B, and causes business data of the new service to be held in the Applet instance 71-3 in an un-personalized state, to place the Applet instance 71-3 in a personalized state.

A state C represents the contactless IC chip 32 in which the Applet instance 71-3 in a blank personalized state has been changed to a personalized state.

As illustrated in FIG. 6, for issuance of a service, the TSM server 12 of the present embodiment once changes an Applet instance in a blank personalized state to an un-personalized state. The TSM server 12 stores implementation data about a new service in a service-undetermined allocation area allocated to the Applet instance in an un-personalized state. This prevents a situation in which an allocation area allocated to an Applet instance in a blank personalized state remains from occurring, thereby enabling effective use of the memory area of the SE. It is also possible to prevent a situation in which the number of services that can be issued is limited to the smaller number than originally expected, or the like, from occurring. Note that, in issuing a new service to a service-undetermined allocation, it is also possible to issue a new service that changes an Applet instance stored in the allocation area.

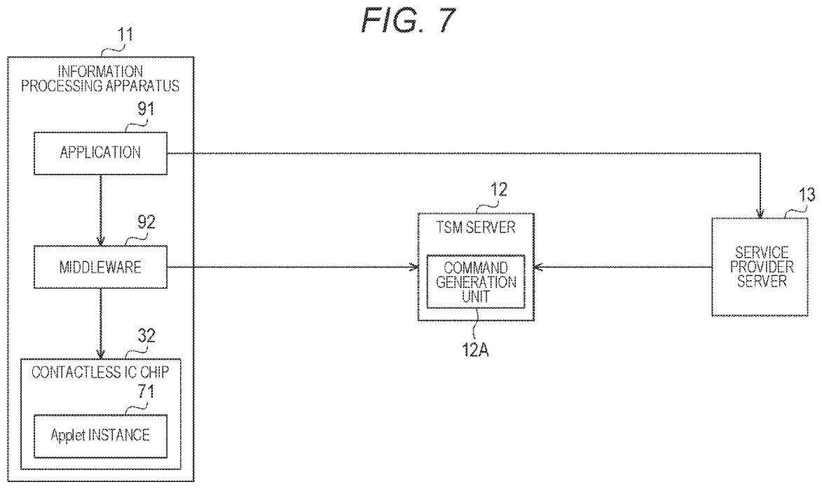

FIG. 7 is a diagram illustrating a configuration concerning service issuance to the contactless IC chip 32 of the information processing apparatus 11 in the information processing system 1 in FIG. 1. Note that, the same portions as those in the information processing system 1 in FIG. 1 are denoted by the same reference signs, and detailed description thereof is omitted.

In the information processing system 1 in FIG. 7, paths (directions of request signals) of data exchanged among the information processing apparatus 11, the TSM server 12, and the service provider server 13 in FIG. 1 are shown by connecting lines with arrows. In the contactless IC chip 32, any Applet instance generated in the SE of the contactless IC chip 32 is represented as an Applet instance 71.

The information processing apparatus 11 includes the contactless IC chip 32, an application 91, and middleware 92.

The application 91 is software executed in the controller 31 in FIG. 1, and mainly exchanges data with a user and the service provider server 13.

The middleware 92 is software executed in the controller 31 of FIG. 1, and is a processing unit that performs various processes when the controller 31 (CPU) executes a predetermined program. The middleware 92 exchanges data with the contactless IC chip 32, with the application 91, and with the TSM server 12. However, the middleware 92 may include software executed by the contactless IC chip 32. The middleware 92 can manage the memory area of the SE in the contactless IC chip 32 on the basis of a command or the like supplied from the TSM server 12. The middleware 92 operates as a processing unit that performs a service issuance process in the information processing apparatus 11. For example, when the TSM server 12 performs a service issuance process as illustrated in FIG. 6, the middleware 92 performs a process of changing a service-determined allocation area allocated to an Applet instance in a blank personalized state in the SE of the contactless IC chip 32 to a service-undetermined allocation area and a service issuance process such as a process of storing implementation data corresponding to a new service in the service-undetermined allocation area, in the information processing apparatus 11.

The TSM server 12 exchanges data with the middleware 92 and with the service provider server 13. The TSM server 12 includes a command generation unit 12A that performs the service issuance process as illustrated in FIG. 6 when the CPU (not illustrated) executes a program for the service issuance process. That is, the TSM server 12 functions as an information processing apparatus including the command generation unit 12A. For example, the command generation unit 12A of the TSM server 12 as the information processing apparatus generates a command that causes the information processing apparatus 11 as a terminal apparatus to perform a process of changing a service-determined allocation area allocated to an Applet instance in a blank personalized state in the SE of the contactless IC chip 32 to a service-undetermined allocation area and a service issuance process in the information processing apparatus 11, such as a process of storing implementation data corresponding to a new service in the service-undetermined allocation area, and supplies (transmits) the generated command or the like to the information processing apparatus 11. Note that, in the following description, the process of the command generation unit 12A is regarded as a process of the TSM server 12, and description of the command generation unit 12A is omitted.

The service provider server 13 exchanges data with the application 91 and with the service provider server 13.

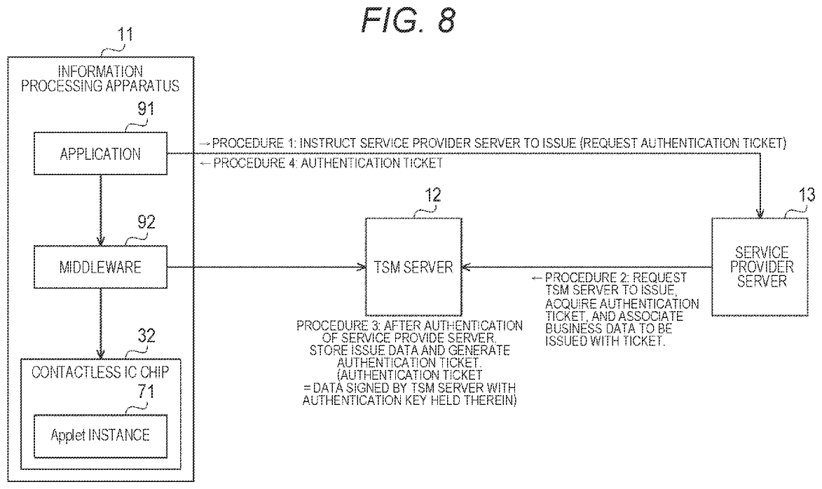

FIGS. 8 to 10 are diagrams illustrating procedures for service issuance in a case where a memory area (a service-undetermined allocation area allocated to an Applet instance in an un-personalized state) to be added with a new service remains in the SE of the contactless IC chip 32. Note that the procedures for service issuance illustrated in FIGS. 8 to 10 correspond to procedures for service issuance in a GP-compatible TSM server to which the present technology is not applied.

In FIG. 8, for example, when a user performs a request operation for service issuance, the application 91 instructs the service provider server 13 to issue a service (procedure 1). Specifically, the application 91 requests the service provider server 13 to acquire an authentication ticket necessary for service issuance.

When the application 91 makes a request for acquisition of an authentication ticket according to the procedure 1, the service provider server 13 transmits business data necessary for service issuance to the TSM server 12, and makes a request for service issuance and a request for an authentication ticket (procedure 2).

Upon receiving the request for service issuance from the service provider server 13 according to the procedure 2, the TSM server 12 authenticates that a communication partner having made the request is not a forged server but the service provider server 13, then accepts the request for service issuance, and stores therein the business data (issuance data necessary for service issuance) acquired from the service provider server 13. The TSM server 12 generates an authentication ticket and transmits the authentication ticket to the service provider server 13 (procedure 3). The authentication ticket is data signed by the TSM server 12 with an authentication key held therein.

The service provider server 13 transmits the authentication ticket acquired from the TSM server 12 according to the procedure 3, to the application 91 (procedure 4).

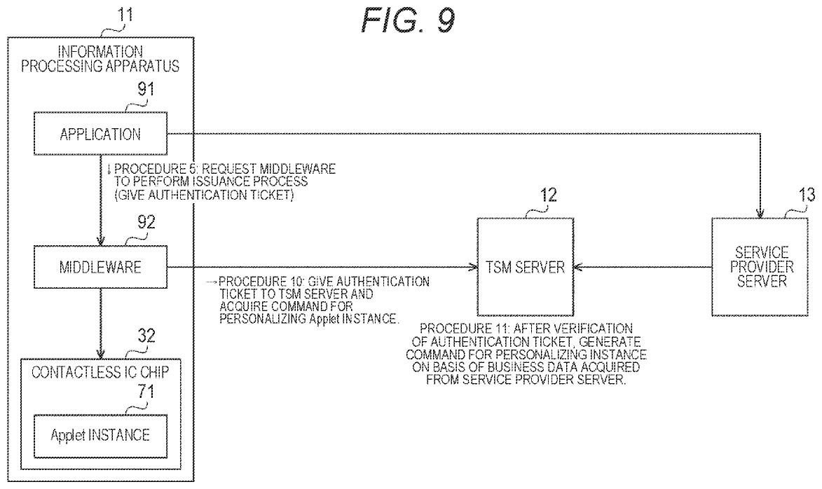

In FIG. 9, when acquiring the authentication ticket from the service provider server 13 according to the procedure 4, the application 91 requests the middleware 92 to perform a service issuance process and gives the authentication ticket (procedure 5).

Upon the request for a service issuance process from the application 91 according to the procedure 5, the middleware 92 transmits the authentication ticket acquired from the application 91 to the TSM server 12 and makes a request for a command for personalizing the Applet instance 71 (procedure 10).

The TSM server 12 verifies that the authentication ticket acquired from the middleware 92 according to the procedure 10 is the authentication ticket generated in the procedure 3 (see FIG. 8). After the verification, the TSM server 12 generates a command for personalizing the Applet instance 71 in an un-personalized state on the basis of the business data acquired from the service provider server 13 in the procedure 3, and transmits the command to the middleware 92 (procedure 11).

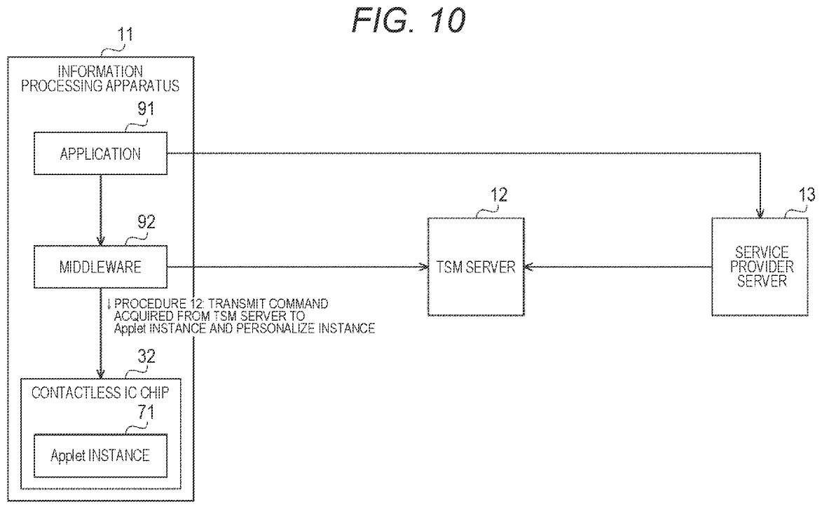

In FIG. 10, when acquiring the command from the TSM server 12 according to the procedure 11, the middleware 92 transmits the acquired command to the Applet instance 71 and personalizes the Applet instance 71 (procedure 12). Thus, implementation data for implementation of a newly added service is stored in a service-undetermined allocation area, and a new service is issued.

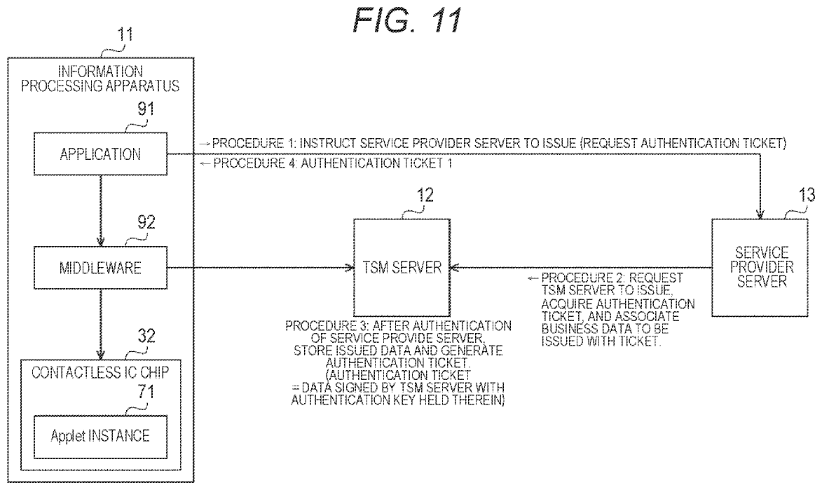

FIGS. 11 to 16 are diagrams illustrating procedures for service issuance to the Applet instance 71 in a blank personalized state in a case where no memory area to be added with a new service remains in the SE of the contactless IC chip 32. Note that the same procedures as those illustrated in FIGS. 8 to 10 are denoted by the same procedure numbers, and description thereof is omitted as appropriate.

In FIG. 11, for example, when a user performs a request operation for service issuance, the application 91 instructs the service provider server 13 to issue a service (procedure 1). Thus, the application 91 acquires an authentication ticket 1 from the TSM server 12 via the service provider server 13 (procedures 2 to 4). Note that the authentication ticket acquired by the application 91 from the TSM server 12 according to the procedures 1 to 4 is referred to as an authentication ticket 1 in order to avoid confusion with an authentication ticket to be generated by the middleware 92 according to a procedure 7 described later.

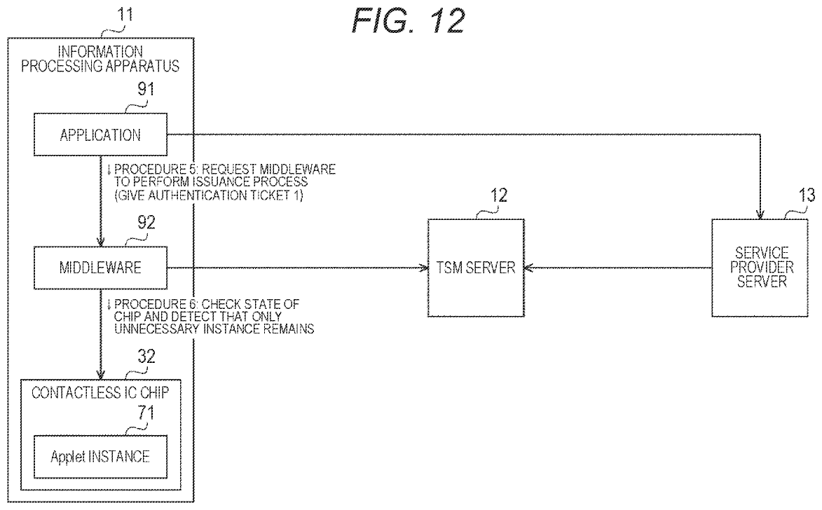

In FIG. 12, when acquiring the authentication ticket 1 from the service provider server 13 according to the procedure 4, the application 91 requests the middleware 92 to perform a service issuance process and gives the authentication ticket 1 (procedure 5).

Upon the request for a service issuance process from the application 91 according to the procedure 5, the middleware 92 checks the state of the contactless IC chip 32, and detects that only an area of the Applet instance 71 in a blank personalized state (hereinafter referred to as an unnecessary instance) remains as a memory area usable for issuance of a new service (procedure 6). Note that the unnecessary instance is also an Applet instance of a service-determined allocation area in which at least a part of implementation data necessary for implementation of a service is deleted.

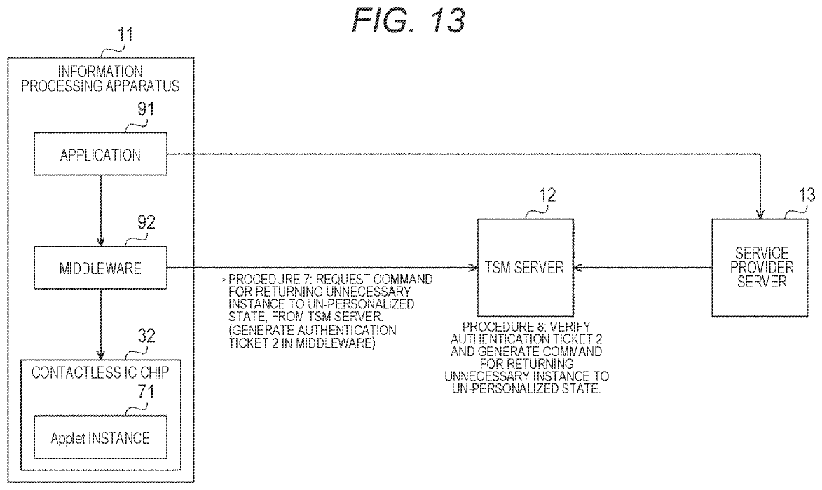

In FIG. 13, when detecting that only the area of the unnecessary instance remains as a memory area usable for service issuance according to the procedure 6, the middleware 92 makes a request for a command for returning the unnecessary instance to an un-personalized state (procedure 7). The middleware 92 generates an authentication ticket 2 in the procedure 7, and transmits it to the TSM server 12. The authentication ticket 2 is data signed by the middleware 92 with an authentication key held therein.

The TSM server 12 verifies the authentication ticket 2 acquired from the middleware 92 according to the procedure 7, generates a command for returning the unnecessary instance to an un-personalized state, and transmits the command to the middleware 92 (procedure 8).

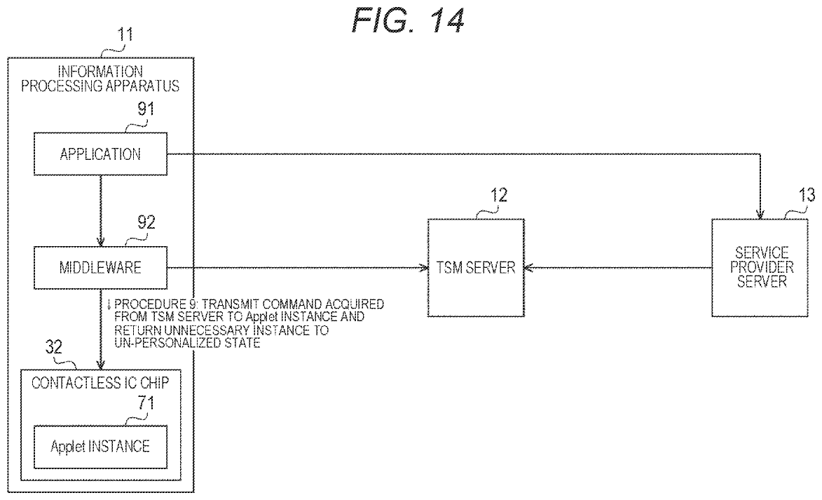

In FIG. 14, when acquiring the command from the TSM server 12 according to the procedure 8, the middleware 92 transmits the acquired command to the Applet instance 71 that is the unnecessary instance, to return the Applet instance 71 to an un-personalized state (procedure 9).

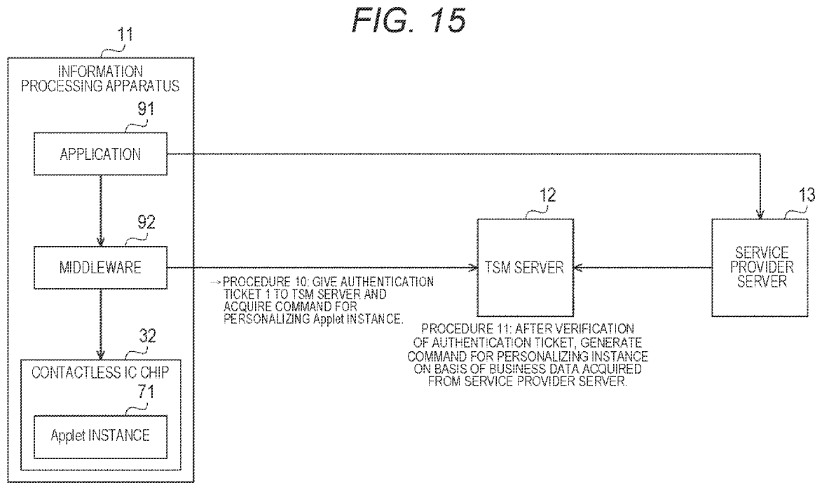

In FIG. 15, the middleware 92 transmits the authentication ticket 1 acquired from the application 91 according to the procedure 5 to the TSM server 12, and makes a request for a command for personalizing the Applet instance 71 in an un-personalized state (procedure 10). Thus, the middleware 92 acquires a command for personalizing the Applet instance 71 from the TSM server 12 (procedure 11).

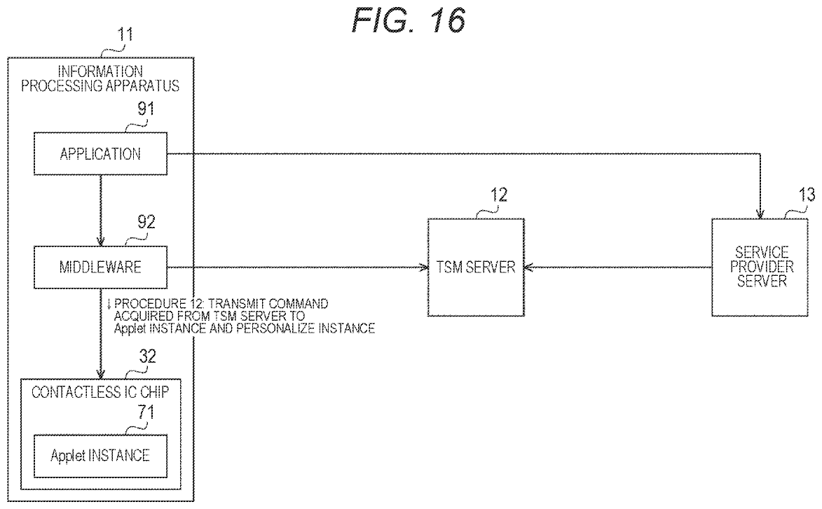

In FIG. 16, the middleware 92 transmits the command acquired from the TSM server 12 according to the procedure 11, to the Applet instance 71 and personalizes the Applet instance 71 (procedure 12). As a result, a service is issued.

According to the above-described procedures 1 to 12, in a case where no memory area for issuing a service remains in the SE of the contactless IC chip 32, an unnecessary instance in a blank personalized state is returned to an un-personalized state, and a service is issued to the unnecessary instance. That is, after a service-determined allocation area allocated to the unnecessary instance is returned to a service-undetermined allocation area, implementation data corresponding to a new service is stored in the allocation area. This prevents a situation in which an allocation area allocated to an Applet instance in a blank personalized state remains from occurring, thereby enabling effective use of the memory area of the SE. It is also possible to prevent a situation in which the number of services that can be issued is limited to the smaller number than originally expected, or the like, from occurring.

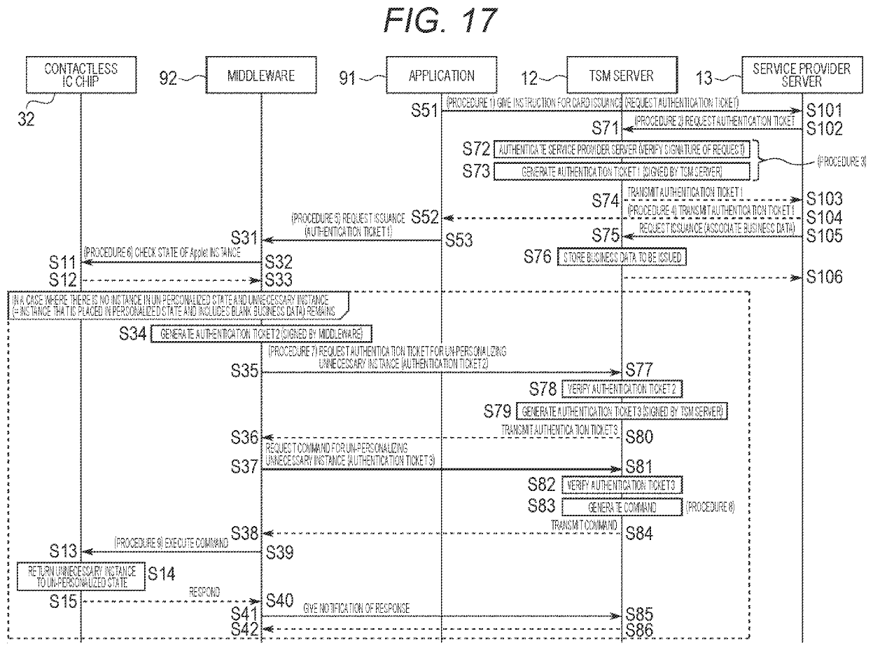

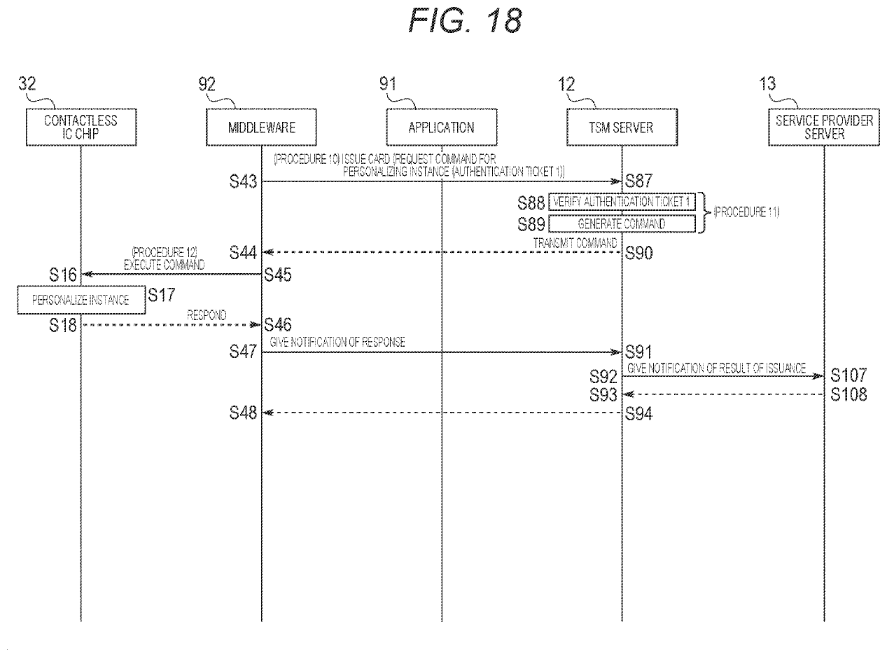

FIGS. 17 and 18 are sequence diagrams illustrating procedures for a service issuance process in the information processing system 1.

In FIG. 17, in step S51, when a user performs a request operation for service issuance, for example, the application 91 instructs the service provider server 13 to issue a service. Specifically, the application 91 requests the service provider server 13 to acquire an authentication ticket necessary for service issuance. Step S51 corresponds to the procedure 1 in FIG. 11.

In step S101, the service provider server 13 receives the request for acquisition of an authentication ticket, made by the application 91 in step S51.

In step S102, the service provider server 13 transmits business data necessary for service issuance to the TSM server 12, and makes a request for service issuance and a request for an authentication ticket. Step S102 corresponds to the procedure 2 in FIG. 11.

In step S71, the TSM server 12 receives the request for service issuance from the service provider server 13, made in step S102.

In step S72, the TSM server 12 verifies the service provider server 13 that has made the request for an authentication ticket in step S102. Specifically, the TSM server 12 verifies the signature of the request (request) of the service provider server 13.

In step S73, the TSM server 12 generates the authentication ticket 1. Note that, step S72 and step S73 correspond to the procedure 3 in FIG. 11.

In step S74, the TSM server 12 transmits the authentication ticket 1 generated in step S73, to the service provider server 13.

In step S103, the service provider server 13 acquires the authentication ticket 1 transmitted from the TSM server 12 in step S74.

In step S104, the service provider server 13 transmits the authentication ticket 1 acquired from the TSM server 12 in step S103, to the application 91. Step S104 corresponds to the procedure 4 in FIG. 11.

In step S52, the application 91 acquires the authentication ticket 1 transmitted from the service provider server 13 in step S104.

In step S53, the application 91 supplies the authentication ticket 1 acquired from the service provider server 13 in step S52, to the middleware 92. Step S53 corresponds to the procedure 5 in FIG. 12.

In step S31, the middleware 92 acquires the authentication ticket 1 supplied from the application 91 in step S53.

In step S32, the middleware 92 requests the contactless IC chip 32 to check a state of an Applet instance.

In step S11, the contactless IC chip 32 receives the request for check of a state of an Applet instance from the middleware 92, made in step S32.

In step S12, the contactless IC chip 32 notifies the middleware 92 of the state of the Applet instance of the SE.

In step S33, the middleware 92 acquires the state of the Applet instance from the contactless IC chip 32 in step S12. Note that step S32 in a case where the middleware 92 is notified that there is no Applet instance in an un-personalized state and only an Applet instance in a blank personalized state (unnecessary instance) remains corresponds to the procedure 6 in FIG. 12. In this case, the process of the middleware 92 proceeds to step S34. In a case where there is an Applet instance in an un-personalized state, the process of the middleware 92 skips steps S34 to S42 and proceeds to step S43. The processes in a range surrounded by a broken line in FIG. 17 are not performed in a case where there is an Applet instance in an un-personalized state.

In step S34, the middleware 92 generates the authentication ticket 2. The authentication ticket 2 is an authentication ticket signed by the middleware 92.

In step S35, the middleware 92 transmits a request for an authentication ticket for returning the unnecessary instance to an un-personalized state, together with the authentication ticket 2 generated in step S34, to the TSM server 12.

In step S77, the TSM server 12 acquires the authentication ticket 2 and the request for an authentication ticket that are transmitted from the middleware 92 in step S35.

In step S78, the TSM server 12 verifies the authentication ticket 2 acquired from the middleware 92 in step S77. Specifically, it is verified that a transmission source that has transmitted the request for the authentication ticket 2 is an authentic transmission source.

In step S79, the TSM server 12 generates an authentication ticket 3. The authentication ticket 3 is signed by the TSM server 12.

In step S80, the TSM server 12 transmits the authentication ticket 3 generated in step S79, to the middleware 92.

In step S36, the middleware 92 acquires the authentication ticket 3 transmitted from the TSM server 12 in step S79.

In step S37, the middleware 92 transmits a request for a command for returning the unnecessary instance to an un-personalized state, together with the authentication ticket 3 acquired from the TSM server 12 in step S36, to the TSM server 12.

In step S81, the TSM server 12 acquires the authentication ticket 3 and the request for a command that are transmitted from the middleware 92 in step S36.

In step S82, the TSM server 12 verifies the authentication ticket 3 acquired from the middleware 92 in step S81.

In step S83, the TSM server 12 generates a command for returning the unnecessary instance to an un-personalized state.

In step S84, the TSM server 12 transmits the command generated in step S83, to the middleware 92.

Note that the processes of steps S35 to S37 in the middleware 92 and the processes of steps S77 to S83 in the TSM server 12 represent details of the processes of the procedure 7 and the procedure 8 in FIG. 13.

In step S38, the middleware 92 acquires the command transmitted from the TSM server 12 in step S83.

In step S39, the middleware 92 gives an instruction for executing the command acquired in step S38, to the contactless IC chip 32 (unnecessary instance). Step S39 corresponds to the procedure 9 in FIG. 14.

In step S13, the contactless IC chip 32 (unnecessary instance) receives the instruction for executing the command from the middleware 92, given in step S39.

In step S14, the contactless IC chip 32 (unnecessary instance) executes the command received in step S38. As a result, the unnecessary instance is returned to an un-personalized state.

In step S15, the contactless IC chip 32 notifies the middleware 92 of a response indicating that the command has been executed in accordance with the instruction given in step S39. In step S40, the middleware 92 acquires the response from the contactless IC chip 32 in step S15.

In step S41, the middleware 92 notifies the TSM server 12 of a response indicating that the execution of the command transmitted from the TSM server 12 in step S84 has ended.

In step S85, the TSM server 12 acquires the response notification of which is provided by the middleware 92 in step S41.

In step S86, the TSM server 12 notifies the middleware 92 of a response indicating that the response notification of which is provided by the middleware 92 in step S84 has been received.

In step S42, the middleware 92 receives the response notification of which is provided by the TSM server 12 in step S86.

In FIG. 18, in step S43, the middleware 92 transmits a request for a command for issuing a service (personalizing the Applet instance 71), together with the authentication ticket 1 acquired from the application 91 in step S31, to the TSM server 12. Step S43 corresponds to the procedure 10 in FIG. 15.

In step S87, the TSM server 12 acquires the authentication ticket 1 and the request for a command that are transmitted from the middleware 92 in step S43.

In step S88, the TSM server 12 verifies the authentication ticket 1 acquired from the middleware 92 in step S84.

In step S89, the TSM server 12 generates a command corresponding to the request received from the middleware 92 in step S84. In other words, the TSM server 12 generates a command for personalizing the Applet instance 71. Step S88 and step S89 correspond to the procedure 11 in FIG. 15.

In step S90, the TSM server 12 transmits the command generated in step S89, to the middleware 92.

In step S44, the middleware 92 acquires the command transmitted from the TSM server 12 in step S90.

In step S45, the middleware 92 gives an instruction for executing the command acquired in step S44, to the contactless IC chip 32 (Applet instance in an un-personalized state). Step S45 corresponds to the procedure 12 in FIG. 16.

In step S16, the contactless IC chip 32 (Applet instance in an un-personalized state) receives the instruction for executing the command from the middleware 92, given in step S45.

In step S17, the contactless IC chip 32 (Applet instance in an un-personalized state) executes the command received in step S16. As a result, the Applet instance in an un-personalized state is placed in a personalized state, and a service is issued.

In step S18, the contactless IC chip 32 notifies the middleware 92 of a response indicating that the command has been executed in accordance with the instruction given in step S45.

In step S46, the middleware 92 acquires the response from the contactless IC chip 32, given in step S18.

In step S47, the middleware 92 notifies the TSM server 12 of a response indicating that the execution of the command transmitted from the TSM server 12 in step S90 has ended.

In step S91, the TSM server 12 acquires the response notification of which is provided by the middleware 92 in step S47.

In step S92, the TSM server 12 notifies the service provider server 13 of a result of service issuance.

In step S107, the service provider server 13 acquires the result of service issuance notification of which is provided by the TSM server 12 in step S92.

In step S108, the service provider server 13 notifies the TSM server 12 of a response indicating that the result of service issuance notification of which is provided by the TSM server 12 in step S92 has been received.

In step S93, the TSM server 12 acquires the response notification of which is provided by the service provider server 13 in step S93.

In step S94, the TSM server 12 notifies the middleware 92 of a response indicating that the response notification of which is provided by the middleware 92 in step S91 has been received.

In step S48, the middleware 48 acquires the response notification of which is provided by the TSM server 12 in step S94.

By the above-described service issuance process, an unnecessary instance in a blank personalized state is returned to an un-personalized state, and a new service is issued to the unnecessary instance. In other words, a service-determined allocation area in which at least a part of implementation data necessary for implementation of a service is deleted is changed to a service-undetermined allocation area, and a new service is issued to the service-undetermined allocation area. Therefore, a situation in which an allocation area not allocated to implementation of a service does not occur, and the memory area of the SE is effectively used. It is also possible to prevent a situation in which the number of services that can be issued is limited to the smaller number than originally expected, from occurring.

Note that, in the above-described service issuance process, in a case where there is no Applet instance in an un-personalized state in the SE of the contactless IC chip 32, in other words, in a case where there is no service-undetermined allocation area, a new service is issued to an Applet instance in a blank personalized state, in other words, to a service-determined allocation area in which at least a part of implementation data is deleted. The present technology is not limited to the above-described process, and can be applied to a process in which, in a case where there is an Applet instance in a blank personalized state, in other words, in a case where there is a service-determined allocation area in which at least a part of implementation data is deleted, a new service is issued to the Applet instance in a blank personalized state, in other words, to the service-determined allocation area in which at least a part of implementation data is deleted.

### <Program>

The above-described series of processes in the information processing system 1, the contactless IC chip 32, the middleware 92, the TSM server 12, or the service provider server 13 can be performed by hardware or software. In a case where the series of processes is performed by software, a program forming the software is installed on a computer. Here, the computer includes a computer incorporated in dedicated hardware, for example, a general-purpose personal computer capable of performing various functions by installation of various programs thereon, and the like.

FIG. 19 is a block diagram illustrating a configuration example of hardware of a computer in a case where the computer performs each process performed by the information processing system 1, the contactless IC chip 32, the middleware 92, the TSM server 12, or the service provider server 13, in accordance with a program.

In the computer, a central processing unit (CPU) 201, a read only memory (ROM) 202, and a random access memory (RAM) 203 are connected to each other by a bus 204.

The bus 204 is further connected to an input/output interface 205. The input/output interface 205 is connected to an input unit 206, an output unit 207, a storage unit 208, a communication unit 209, and a drive 210.

The input unit 206 includes a keyboard, a mouse, a microphone, and the like. The output unit 207 includes a display, a speaker, and the like. The storage unit 208 includes a hard disk, a non-volatile memory, and the like. The communication unit 209 includes a network interface and the like. The drive 210 drives a removable medium 211 such as a magnetic disk, an optical disk, a magnetooptical disk, or a semiconductor memory.

In the computer configured as described above, for example, the CPU 201 loads the program stored in the storage unit 208 into the RAM 203 via the input/output interface 205 and the bus 204 and executes the program, to thereby perform the above-described series of processes.

The program executed by the computer (CPU 201) can be provided by being recorded on the removable medium 211 as a package medium or the like, for example. Furthermore, the program can be provided via a wired or wireless transmission medium such as a local area network, the Internet, or digital satellite broadcasting.

In the computer, installation of the program on the storage unit 208 via the input/output interface 205 can be achieved by insertion of the removable medium 211 into the drive 210. Alternatively, installation of the program on the storage unit 208 can be achieved by reception of the program at the communication unit 209 via a wired or wireless transmission medium. Additionally, the program may be installed in advance on the ROM 202 and the storage unit 208.

Note that the program executed by the computer may be a program in which the processes are performed in a time-series manner in the order described in the present specification, or may be a program in which the processes are performed in parallel or at respective necessary timings such as a timing when a call is made.

The present technology can also have the following configurations.

(1)

An information processing apparatus including a processing unit configured to perform a process of changing an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area.

(2)

The information processing apparatus according to (1) described above, in which the processing unit is configured to perform the service issuance process in a case where there is no service-undetermined allocation area in the memory area.

(3)

The information processing apparatus according to (1) or (2) described above, in which the service is a service providable by an IC card.

(4)

The information processing apparatus according to any of (1) to (3) described above, in which a unit of the service is a provider that provides the service or a purpose of using the service.

(5)

The information processing apparatus according to any of (1) to (4) described above, in which the implementation data includes user-specific data.

(6)

The information processing apparatus according to any of (1) to (5) described above, in which the memory area is a memory area in a secure element.

(7)

The information processing apparatus according to any of (1) to (6) described above, in which the memory area is a memory area accessible by a device that is connected so as to be capable of communicating through near field communication.

(8)

The information processing apparatus according to any of (1) to (7) described above, in which the memory area is a memory area in a non-volatile memory incorporated in a contactless IC chip.

(9)

The information processing apparatus according to any of (1) to (8) described above, in which the memory area is managed in accordance with a specification defined by GlobalPlatform.

(10)

The information processing apparatus according to (9) described above, in which the allocation area remaining being allocated to the predetermined service is a memory area allocated to a service that is deleted in accordance with a technical specification of FeliCa (registered trademark).

(11)

The information processing apparatus according to any of (1) to (10) described above, in which the processing unit is a processing unit configured to perform a process of middleware, and the memory area is a memory area manageable by the middleware.

(12)

The information processing apparatus according to (11) described above, in which the middleware manages the memory area on the basis of a command from a server apparatus that is connected so as to be capable of communicating to/from the middleware.

(13)

An information processing apparatus including a command generation unit configured to transmit, to a terminal apparatus configured to change an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area, a command for performing the service issuance process.

(14)

The information processing apparatus according to (13) described above, in which the command generation unit is configured to transmit the command for performing the service issuance process in a case where there is no service-undetermined allocation area in the memory area.

(15)

A program that causes a computer to function as a processing unit configured to perform a process of changing an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area.

### REFERENCE SIGNS LIST

1 Information processing system
11 Information processing apparatus
12 TSM server
12A Command generation unit
13 Service provider server
14 Reader/writer terminal
31 Controller
32 Contactless IC chip
91 Application
92 Middleware

1. An information processing apparatus comprising
a processing unit configured to perform a process of changing an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area.

2. The information processing apparatus according to claim 1, wherein the processing unit is configured to perform the service issuance process in a case where there is no service-undetermined allocation area in the memory area.

3. The information processing apparatus according to claim 1, wherein the service is a service providable by an IC card.

4. The information processing apparatus according to claim 1, wherein a unit of the service is a provider that provides the service or a purpose of using the service.

5. The information processing apparatus according to claim 1, wherein the implementation data includes user-specific data.

6. The information processing apparatus according to claim 1, wherein the memory area is a memory area in a secure element.

7. The information processing apparatus according to claim 1, wherein the memory area is a memory area accessible by a device that is connected so as to be capable of communicating through near field communication.

8. The information processing apparatus according to claim 1, wherein the memory area is a memory area in a non-volatile memory incorporated in a contactless IC chip.

9. The information processing apparatus according to claim 1, wherein the memory area is managed in accordance with a specification defined by GlobalPlatform.

10. The information processing apparatus according to claim 9, wherein the allocation area remaining being allocated to the predetermined service is a memory area allocated to a service that is deleted in accordance with a technical specification of FeliCa (registered trademark).

11. The information processing apparatus according to claim 1, wherein the processing unit is a processing unit configured to perform a process of middleware, and the memory area is a memory area manageable by the middleware.

12. The information processing apparatus according to claim 11, wherein the middleware manages the memory area on a basis of a command from a server apparatus that is connected so as to be capable of communicating to/from the middleware.

13. An information processing apparatus comprising
a command generation unit configured to transmit, to a terminal apparatus configured to change an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area, a command for performing the service issuance process.

14. The information processing apparatus according to claim 13, wherein the command generation unit is configured to transmit the command for performing the service issuance process in a case where there is no service-undetermined allocation area in the memory area.

15. A program that causes a computer to function as a processing unit configured to perform a process of changing an allocation area that is placed in a state in which at least a part of implementation data necessary for implementation of each of one or more services is deleted and remains being allocated to a predetermined service, among allocation areas respectively allocated to the one or more services in a memory area in which the implementation data is stored, to a service-undetermined allocation area not allocated to any of the services, and thereafter perform a service issuance process of storing the implementation data corresponding to a new service in the service-undetermined allocation area.
